(19) United States
(12) Patent Application Publication
(10) Pub. No.: US 2024/0314710 A1
(43) Pub. Date: Sep. 19, 2024

(54) METHOD AND DEVICE IN NODES USED FOR WIRELESS COMMUNICATION

(71) Applicant: Xiaobo ZHANG, Shanghai (CN)

(72) Inventor: Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/676,509

(22) Filed: May 29, 2024

Related U.S. Application Data
(63) Continuation of application No. PCT/CN2022/133914, filed on Nov. 24, 2022.

(30) Foreign Application Priority Data
Dec. 2, 2021 (CN) 202111457560.6

(51) Int. Cl. H04W 56/00; H04L 5/00; H04W 72/0446

(52) U.S. Cl. CPC H04W 56/001; H04L 5/0048; H04W 72/0446

(57) ABSTRACT

The present application provides a method and device in a node for wireless communications. A first node receives a first signaling and a second signaling, the first signaling indicates that Q SSBs are transmitted, and the Q SSBs respectively correspond to Q SSB indexes, the Q SSB indexes are respectively used to determine Q time-domain resources, Q being a positive integer greater than 1; determines a first time-domain resource based on at least a first integer, a candidate of the first time-domain resource constitutes a first time-domain resource pool; monitors a downlink control signaling in the first time-domain resource. The present application has good compatibility and improves the flexibility of resource allocation.

### CROSS REFERENCE TO RELATED APPLICATIONS

This application is the continuation of the international patent application No. PCT/CN2022/133914, filed on Nov. 24, 2022, and claims the priority benefit of Chinese Patent Application No. 202111457560.6, filed on Dec. 2, 2021, the full disclosure of which is incorporated herein by reference.

### BACKGROUND

### Technical Field

The present application relates to transmission methods and devices in wireless communication systems, and in particular to a transmission method and device of a radio signal in a wireless communication system supporting cellular networks.

### Related Art

In LTE (Long term Evolution) systems, traditional Network Controlled mobility comprises cell level mobility and beam level mobility, where cell level mobility depends on a Radio Resource Control (RRC) signaling and beam level mobility does not involve an RRC signaling. In 3GPP (3rd Generation Partnership Project) R (Release) 16 and previous releases, an SSB (SS/PBCH Block) index is used to determine time-domain resources occupied by a corresponding CSS (Common Search Space) set.

### SUMMARY

Associating a CSS set to an SSB of a serving cell can improve the efficiency of the UE (User Equipment) in performing Blind Decoding for a PDCCH (Physical Downlink Control CHannel). However, the above scheme limits the flexibility of resource allocation and may need to be further enhanced in future evolution versions of the cellular network.

To address the above problem, the present application provides a solution. It should be noted that although the above description uses cellular networks or CSS as an example, the present application is also applicable to other scenarios such as sidelink transmission or USS (UE specific Search Space), where similar technical effects can be achieved. Besides, a unified solution for different scenarios (including but not limited to cellular networks and sidelink transmission) can also help reduce hardware complexity and cost. If no conflict is incurred, embodiments in a first node and the characteristics of the embodiments in the present application are also applicable to a second node, and vice versa. And the embodiments and the characteristics in the embodiments in the present application can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving a first signaling and a second signaling, the first signaling indicating that Q SSBs are transmitted, and the Q SSBs respectively corresponding to Q SSB indexes, the Q SSB indexes respectively being used to determine Q time-domain resources, Q being a positive integer greater than 1; determining a first time-domain resource based on at least a first integer, a candidate of the first time-domain resource constituting a first time-domain resource pool; monitoring a downlink control signaling in the first time-domain resource;
herein, the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI (Physical Cell Identifier).

In one embodiment, the technical characteristics of the Q SSB indexes being respectively used to determine the Q time-domain resources maintain compatibility with existing systems; the technical feature that the first time-domain resource pool is one of a first candidate pool and a second candidate pool provides a flexibility of resource allocation; thus, the above approach strikes a balance between compatibility and flexibility.

Typically, each of the Q time-domain resources comprises at least one PDCCH monitoring occasion.

Typically, each of the Q time-domain resources comprises at least one multicarrier symbol.

Typically, each of the Q time-domain resources comprises at least one slot.

In one embodiment, the multicarrier symbol is an Orthogonal Frequency Division Multiplexing (OFDM) symbol.

In one embodiment, the multicarrier symbol is a DFT-S-OFDM symbol.

Specifically, according to one aspect of the present application, the feature is that the second signaling indicates Q2 SSB indexes in the Q SSB indexes, and the Q2 SSB indexes are respectively used to determine the Q2 time-domain resources.

In one embodiment, the above method maintains better compatibility with existing systems.

Typically, the first time-domain resource is a time-domain resource in the first time-domain resource pool.

Typically, any of the Q2 time-domain resources is one of the Q time-domain resources.

Typically, any two SSB indexes in Q2 SSB indexes are different.

Specifically, according to one aspect of the present application, the feature is that at least for the first node, SSBs corresponding to the Q2 SSB indexes are considered not actually transmitted.

In one embodiment, the above method can provide greater scheduling flexibility.

In one embodiment, the above method improves the efficiency of UE in performing blind decoding.

In one embodiment, the second signaling is used to indicate that SSBs corresponding to the Q2 SSB indexes are not actually transmitted.

In one embodiment, the second signaling is used to indicate dropping using SSBs corresponding to the Q2 SSB indexes for cell search.

In one embodiment, for a traditional UE, SSBs corresponding to the Q2 SSB indexes are considered to be actually transmitted.

Typically, the traditional UE cannot identify the second signaling.

In one embodiment, the traditional UE comprises a UE that at least supports 3GPP Release 15 and a UE that supports 3GPP Release 16.

In one embodiment, the traditional UE comprises a UE in 3GPP Release 17.

Specifically, according to one aspect of the present application, the feature is that for any of the Q2 time-domain resources, the Q time-domain resources comprise a corresponding time-domain resource; the second signaling is used to indicate the any time-domain resource from the corresponding time-domain resource.

In one embodiment, the above method can achieve smaller granularity resource scheduling, further improving scheduling flexibility.

Specifically, according to one aspect of the present application, the feature is that the Q time-domain resources each hold Q groups of CSS (Common Search Space) sets, and each of Q groups of CSS sets comprises at least one CSS set.

Specifically, according to one aspect of the present application, comprising:
the first receiver, receiving a third signaling, the third signaling being used to determine whether the first time-domain resource pool is a first candidate pool or a second candidate pool.

In one embodiment, the above method allows for flexible configuration of the first time-domain resource pool, further improving scheduling flexibility:

Specifically, according to one aspect of the present application, the feature is that whether the first time-domain resource pool is a first candidate pool or a second candidate pool is related to a first RNTI (Radio Network Temporary Identifier), and the downlink control signaling is identified by the first RNTI.

Specifically, according to one aspect of the present application, the feature is that whether the first time-domain resource pool is a first candidate pool or a second candidate pool is related to a CORESET (Control Resource Set) that accommodates the downlink control signaling.

In one embodiment, either of the above two aspects reduces the signaling overhead or time delay used to configure the first time-domain resource pool, thus improving transmission efficiency.

The present application provides a method in a second node for wireless communications, comprising:
transmitting a first signaling and a second signaling, the first signaling indicating that Q SSBs are transmitted, and the Q SSBs respectively corresponding to Q SSB indexes, the Q SSB indexes respectively being used to determine Q time-domain resources, Q being a positive integer greater than 1;
herein, at least a first integer is used to determine a first time-domain resource, and a candidate of the first time-domain resource constitutes a first time-domain resource pool; the first time-domain resource is reserved for a downlink control signaling; the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

The present application provides a first node for wireless communications, comprising:
a first receiver, receiving a first signaling and a second signaling, the first signaling indicating that Q SSBs are transmitted, and the Q SSBs respectively corresponding to Q SSB indexes, the Q SSB indexes respectively being used to determine Q time-domain resources, Q being a positive integer greater than 1; determining a first time-domain resource based on at least a first integer, a candidate of the first time-domain resource constituting a first time-domain resource pool; monitoring a downlink control signaling in the first time-domain resource;
herein, the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

The present application provides a second node for wireless communications, comprising:
a first transmitter, transmitting a first signaling and a second signaling, the first signaling indicating that Q SSBs are transmitted, and the Q SSBs respectively corresponding to Q SSB indexes, the Q SSB indexes respectively being used to determine Q time-domain resources, Q being a positive integer greater than 1;
herein, at least a first integer is used to determine a first time-domain resource, and a candidate of the first time-domain resource constitutes a first time-domain resource pool; the first time-domain resource is reserved for a downlink control signaling; the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

In one embodiment, the present application has the following advantages over conventional schemes:
having good compatibility with existing systems;
providing greater scheduling flexibility.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of monitoring a downlink control signaling according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of wireless communications according to one embodiment of the present application;

FIG. 6 illustrates a schematic diagram of a first node being in communications with a first cell and a second cell according to one embodiment of the present application;

FIG. 7 illustrates a schematic diagram of a first time-domain resource pool according to one embodiment of the present application;

FIG. 8 illustrates a schematic diagram of a cell coverage status of the first node according to one embodiment of the present application;

FIG. 9 illustrates a schematic diagram of transferring a backhaul signaling between a first node and a second node according to one embodiment of the present application;

FIG. 10 illustrates a structure block diagram of a processor in a first node according to one embodiment of the present application;

FIG. 11 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

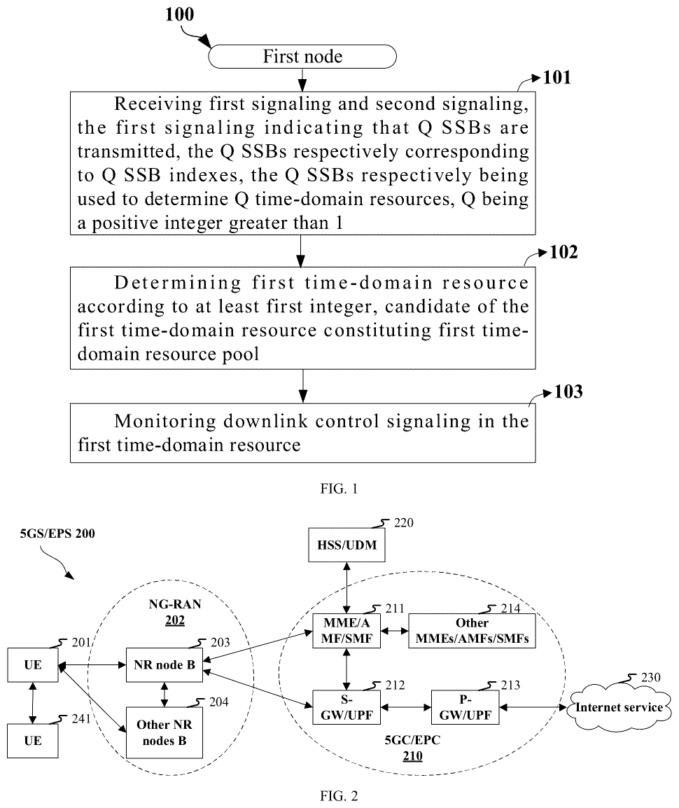

Embodiment 1 illustrates a schematic diagram of monitoring a downlink control signaling according to one embodiment of the present application, as shown in FIG. 1. In step 100 illustrated by FIG. 1, each box represents a step.

The first node 100 receives a first signaling and a second signaling in step 101, the first signaling indicates that Q SSBs are transmitted, and the Q SSBs respectively correspond to Q SSB indexes, and the Q SSB indexes are respectively used to determine Q time-domain resources, Q being a positive integer greater than 1; determines a first time-domain resource based on at least a first integer in step 102, a candidate of the first time-domain resource constitutes a first time-domain resource pool; monitors a downlink control signaling in the first time-domain resource in step 103;

In embodiment 1, the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

Typically, the first signaling is broadcast, and the downlink control signaling is a physical-layer signaling.

In one embodiment, the first signaling is an RRC signaling.

In one embodiment, the first signaling is a System Information Block (SIB) 1.

In one embodiment, the first signaling is an ssb-Positions InBurst field.

In one embodiment, the second signaling is generated at a Radio Resource Control (RRC) layer.

In one embodiment, the second signaling is a Medium Access Control (MAC) CE (Control Element).

In one embodiment, the second signaling is Downlink control information (DCI).

In one subembodiment of the above two embodiments, the second signaling indicates at least one TCI (Transmission Configuration Indicator) state.

In one embodiment, the Q SSB indexes are respectively 1, 2, . . . , and Q.

In one embodiment, the Q SSB indexes are respectively 0, 1, . . . , Q−1.

In one embodiment, the first signaling comprises a bitmap, and Q bits in the bitmap respectively indicate that Q SSBs are transmitted; the Q SSBs correspond to the Q SSB indexes in order of their positions in the Q bits.

Typically, each of the Q time-domain resources comprises at least one PDCCH monitoring occasion.

Typically, the downlink control signaling is a DCI.

In one embodiment, Q2 is less than the Q, any of the Q2 time-domain resources is one of the Q time-domain resources.

In one subembodiment of the above embodiment, Q1 is less than the Q, any of the Q1 time-domain resources is one of the Q time-domain resources.

In one subembodiment of the above embodiment, any of the Q1 time-domain resources does not belong to the Q2 time-domain resources.

In one subembodiment of the above embodiment, the Q time-domain resources consist of the Q1 time-domain resources and the Q2 time-domain resources.

In one subembodiment of the above embodiment, the second signaling uses the method of bitmap to indicate the Q1 time-domain resources from the Q time-domain resources.

In one subembodiment of the above embodiment, the second signaling comprises Q bits, and the Q bits respectively indicate whether one of the Q time-domain resources belongs to the Q1 time-domain resources.

In one embodiment, at least one of the Q2 time-domain resources is a true subset of one of the Q time-domain resources.

In one subembodiment of the above embodiment, a cell identified by the first PCI is not a serving cell of the first node, and a second PCI is used to identify a serving cell of the first node.

In one subembodiment of the above embodiment, a cell identified by the first PCI is not configured with ServCellIndex, while a second PCI is used to identify a serving cell of the first node.

In one embodiment of the above two subembodiments, a TDD-UL-DL-ConfigCommon IE (Information Element) transmitted on a serving cell identified by the second PCI is used to determine the Q1 time-domain resources.

The above several sub-embodiments can avoid the interference of inter-cell cross-links and improve the transmission efficiency.

In one embodiment, any symbol configured as uplink in the TDD-UL-DL-ConfigCommon IE does not belong to the Q1 time-domain resources.

In one embodiment, for any PDCCH monitoring occasion in the Q time-domain resources, if there exists an overlapping with any symbol configured as uplink in the TDD-UL-DL-ConfigCommon IE, the PDCCH monitoring occasion does not belong to the Q1 time-domain resources.

The above method facilitates the first node to receive a downlink control signaling through a cell identified by a second PCI, while maintaining the serving cell unchanged.

The above method facilitates the first node to receive a downlink control signaling through a cell identified by the first PCI, while maintaining the serving cell unchanged, to achieve inter-cell mobility on a lower protocol layer.

In one subembodiment of the above embodiment, Q2 is equal to the Q.

In one subembodiment of the above embodiment, Q1 is equal to the Q, and the Q1 time-domain resources are the Q time-domain resources.

In one subembodiment of the above embodiment, at least one of the Q1 time-domain resources comprises an OFDM symbol not belonging to the Q2 time-domain resources.

In one subembodiment of the above embodiment, the second signaling uses the method of bitmap to indicate the Q1 time-domain resources from at least one of the Q time-domain resources.

In one subembodiment of the above embodiment, the second signaling comprises L bits, and the L bits respectively indicate whether L PDCCH monitoring occasions in one of the Q time-domain resources belongs to one of the Q1 time-domain resources.

In one subembodiment of the above embodiment, the second signaling indicates that at least one search space is associated with the first PCI, and the behavior of monitoring a downlink control signaling is executed in the at least one search space.

In one embodiment, the behavior of monitoring a downlink control signaling comprises judging whether the downlink control signaling is detected based on CRC (Cyclic Redundancy Check).

In one embodiment, the behavior of monitoring a downlink control signaling comprises judging whether the downlink control signaling is transmitted based on CRC.

In one embodiment, the behavior of monitoring a downlink control signaling comprises judging whether the downlink control signaling is detected based on an energy detection.

In one embodiment, the behavior of monitoring a downlink control signaling comprises determining whether the downlink control signaling is detected based on an interference detection of a DMRS (Demodulation Reference Signal).

In one embodiment, the first time-domain resource is a time-domain resource in the first time-domain resource pool.

In one embodiment, the first time-domain resource is a part of a time-domain resource in the first time-domain resource pool.

Typically, the second signaling indicates the Q2 time-domain resources from the Q time-domain resources.

Typically, candidates for the first time-domain resource constitutes the first time-domain resource pool.

Typically, the first time-domain resource is determined from the first time-domain resource pool based on at least a first integer.

In one embodiment, a cell identified by the first PCI and a cell identified by the second PCI are maintained by a same base station.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy; a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the gNB 203.

In one embodiment, the third node in the present application comprises the gNB 203.

In one embodiment, a cell identified by the first PCI and a cell identified by the second PCI in the present application are both maintained by the gNB 203.

In one embodiment, a radio link between the UE 201 and the gNB 203 is a cellular network link.

In one embodiment, transmitters of the first signaling and the second signaling comprise the gNB 203.

In one embodiment, a transmitter of the downlink control signal comprises the gNB 204.

In one embodiment, the UE 201 supports inter-cell mobility centered by L1/L2.

In one embodiment, the UE 201 supports inter-cell multi-TRP.

In one embodiment, the gNB 203 supports inter-cell mobility centered by L1/L2.

In one embodiment, the gNB 203 supports inter-cell multiple transmit/receive points (TRPs).

In one embodiment, the gNB 203 supports Full Duplex Division.

### Embodiment 3

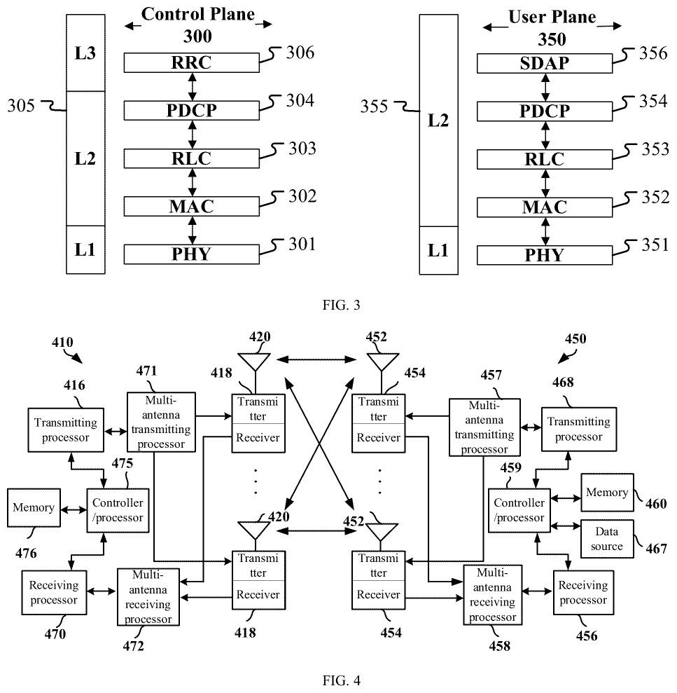

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling is generated at the RRC sublayer 306, and the downlink control signaling is generated at the PHY 301.

In one embodiment, the second signaling is generated by the PHY sublayer 306.

In one embodiment, the second signaling is generated by the MAC sublayer 302.

In one embodiment, the second signaling is generated by the PHY 301.

In one embodiment, a third signaling is generated by the MAC sublayer 302.

In one embodiment, a third signaling is generated by the PHY 301.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first signaling and a second signaling; and determines a first time-domain resource based on at least a first integer; monitors a downlink control signaling in the first time-domain resource.

In one embodiment, the second communication device 450 comprises a memory that stores a computer readable instruction program. The computer readable instruction program generates an action when executed by at least one processor. The action includes: receiving a first signaling and a second signaling; and determining a first time-domain resource based on at least a first integer; monitoring a downlink control signaling in the first time-domain resource.

In one embodiment, the first communication device 410 comprises at least one processor and at least one memory. The at least one memory comprises computer program codes: the at least one memory and the computer program codes are configured to be used in collaboration with the at least one processor. The first communication device 410 at least: transmits a first signaling and a second signaling.

In one embodiment, the first communication device 410 comprises a memory that stores a computer readable instruction program. The computer readable instruction program generates an action when executed by at least one processor. The action includes: transmitting a first signaling and a second signaling.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first signaling and the second signaling; at least one of the antenna 420, the transmitter 418, the transmitting processor 416, the multi-antenna transmitting processor 471, the controller/processor 475, or the memory 476 is used to transmit the first signaling and the second signaling.

In one embodiment, at least one of the antenna 452, the receiver 454, the receiving processor 456, the multi-antenna receiving processor 458, the controller/processor 459, the memory 460, or the data source 467 is used to determine a first time-domain resource according to at least a first integer.

In one embodiment, at least one of the antenna 452, the receiver 454, the receiving processor 456, the multi-antenna receiving processor 458, the controller/processor 459, the memory 460, or the data source 467 is used to monitor a downlink control signaling in the first time-domain resource.

In one embodiment, at least one of the antenna 420, the receiver 418, the receiving processor 416, the multi-antenna transmitting processor 471, the controller/processor 475, or the memory 476 is used to transmit a downlink control signaling in the first time-domain resource.

### Embodiment 5

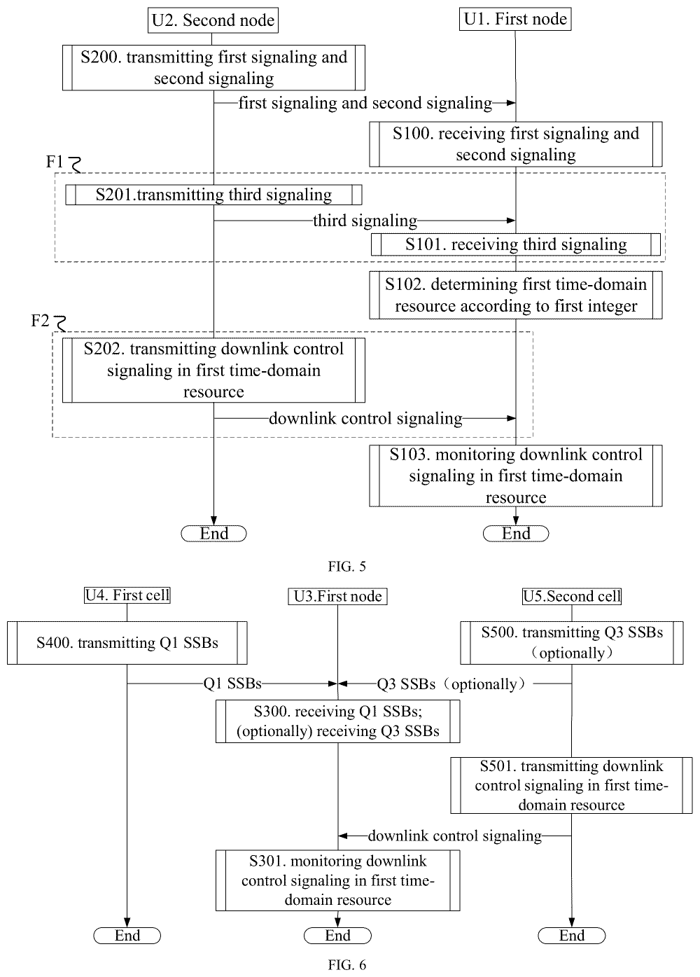

Embodiment 5 illustrates a flowchart of wireless communications according to one embodiment in the present application, as shown in FIG. 5. In FIG. 5, each step in block F1 to block F2 is optional.

The first node U1 receives a first signaling and a second signaling in step S100, the first signaling indicates that Q SSBs are transmitted, and the Q SSBs respectively correspond to Q SSB indexes, and the Q SSB indexes are respectively used to determine Q time-domain resources, Q being a positive integer greater than 1; receives a third signaling in step S101, the third signaling is used to determine whether the first time-domain resource pool is a first candidate pool or a second candidate pool; determines a first time-domain resource based on at least a first integer in step S102, a candidate of the first time-domain resource constitutes a first time-domain resource pool; monitors a downlink control signaling in the first time-domain resource in step S103;
the second node U2 transmits the first signaling and the second signaling in step S200; transmits the third signaling in step S201; transmits the downlink control signaling in step S202.

In embodiment 5, the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

Typically, the Q time-domain resources each hold Q groups of CSS sets, and each of Q groups of CSS sets comprises at least one CSS set.

In one embodiment, the first time-domain resource pool comprises multiple time slices, and the multiple time slices are sequentially indexed in chronological order: for any of the multiple time slices, if an index of the any time slice is equal to f (first integer), the any time slice belongs to the first time-domain resource; if an index of the any time slice is not equal to f (first integer), the any time slice does not belong to the first time-domain resource; the f (first integer) is a function, and an input of the f (first integer) comprises at least the first integer.

In one embodiment, indexes of the multiple time slices are 0, 1, 2, . . . in order.

In one embodiment, indexes of the multiple time slices are 1, 2, . . . in order.

In one embodiment, each of the multiple time slices comprises at least one multicarrier symbol.

In one embodiment, numbers of multicarrier symbols comprised in any two of the multiple slots are the same.

In one embodiment, any of the multiple slots is a PDCCH monitoring occasion.

In one embodiment, any of the multiple slots is a slot.

In one embodiment, the f (first integer) is linear.

In one embodiment, an output of f (first integer) comprises multiple values, and if an index of the first time slice is equal to any of the multiple values, the any time slice belongs to the first time-domain resource.

In one embodiment, an input of the f (a first integer) also comprises x, x is a positive integer from 0 to X−1, and X is configured by a higher-layer signaling.

In one embodiment, the time slice is a PDCCH monitoring occasion, and the f (first integer) is [x*Q+first integer]; the x=0, 1, . . . , X−1, X is configurable.

In one embodiment, the downlink control signaling is identified by a P-RNTI (Paging RNTI), and the first time-domain resource pool belongs to a PO (Paging Occasion).

In one subembodiment of the above embodiment, X is indicated by nrofPDCCH-MonitoringOccasionPerSSB-InPO.

In one embodiment, the downlink control signaling is identified by an SI-RNTI (System Information RNTI), and the first time-domain resource pool belongs to an SI-window.

In one subembodiment of the above embodiment, X is CEIL (a number of PDCCH monitoring occasion(s) in the SI-window/Q), and the CEIL is a rounding up function.

In one embodiment, the SI-window is an SI-window occupied by an SI message of any entry in schedulingInfoList.

In one embodiment, the schedulingInfoList belongs to si-SchedulingInfo of SIB1.

In one embodiment, the second signaling indicates Q2 SSB indexes in the Q SSB indexes, and the Q2 SSB indexes are respectively used to determine the Q2 time-domain resources.

In one subembodiment of the above embodiment, the first time-domain resource is a time-domain resource in the first time-domain resource pool.

In one subembodiment of the above embodiment, any of the Q2 time-domain resources is one of the Q time-domain resources.

Typically, the first time-domain resource is a time-domain resource determined by the first integer in the first time-domain resource pool.

In one embodiment, at least for the first node U1, SSBs corresponding to the Q2 SSB indexes are considered not actually transmitted.

Advantages of the above methods include: maintaining good compatibility with traditional UE, while releasing Q2 SSBs and associated PDCCH monitoring occasions.

In one subembodiment of the above embodiment, the second signaling is used to indicate that at least SSBs corresponding to the Q2 SSB indexes of the first node U1 are not actually transmitted.

In one subembodiment of the above embodiment, the second signaling is used to indicate at least the first node U1 to drop using SSBs corresponding to the Q2 SSB indexes for cell search.

In one subembodiment of the above embodiment, for traditional UE, SSBs corresponding to the Q2 SSB indexes are considered to be actually transmitted.

Typically, the traditional UE cannot identify the second signaling.

In one embodiment, the traditional UE comprises a UE that at least supports 3GPP Release 15 and a UE that supports 3GPP Release 16.

In one embodiment, the traditional UE comprises a UE in 3GPP Release 17.

In one embodiment, for any of the Q2 time-domain resources, the Q time-domain resources comprise a corresponding time-domain resource; the second signaling is used to indicate the any time-domain resource from the corresponding time-domain resource.

In one subembodiment of the above embodiment, time-domain resource #i (i=0, 1, 2, . . . , Q2−1) is any of the Q2 time-domain resources, and time-domain resource #j in the Q time-domain resources corresponds to the time-domain resource #i; the time-domain resource #j comprises PDCCH monitoring occasions #0, #1, #2, . . . ; the second signaling indicates a monitoring occasion belonging to the time-domain resource #i from a PDCCH monitoring occasion comprised in the time-domain resource #j.

In one embodiment, the second signaling uses the method of bitmap to indicate whether each of PDCCH monitoring occasions comprised in the time-domain resource #j belongs to the time-domain resource #i.

In one subembodiment of the above embodiment, the Q2 time-domain resources respectively correspond to Q2 different time-domain resources among the Q time-domain resources.

Typically, the third signaling is generated at the protocol layer below the Radio Resource Control (RRC) layer.

In one embodiment, the third signaling is a Medium Access Control (MAC) CE (Control Element).

In one embodiment, the third signaling is a Downlink Control Information (DCI).

In one embodiment, the third signaling indicates that at least one search space is associated with the first PCI, and the behavior of monitoring a downlink control signaling is executed in the at least one search space.

In one embodiment, the third signaling indicates that at least one search space switches from being associated with the first PCI to being associated with the second PCI, and the behavior of monitoring a downlink control signaling is executed in the at least one search space: the first PCI is different from the second PCI.

In one subembodiment of the above embodiment, Q2 is less than the Q, any of the Q2 time-domain resources is one of the Q time-domain resources.

In one subembodiment of the above embodiment, Q1 is less than the Q, any of the Q1 time-domain resources is one of the Q time-domain resources.

In one embodiment, when a TCI state used for a PDCCH reception in a search space is indicated as being Quasi co-located (QCLed) with an SSB identified by a PCI, the search space is associated with the PCI.

In one embodiment, when a TCI state used for a PDCCH reception in a CORESET (Control resource set) is indicated as Quasi co-location (QCL) identified by a PCI, a search space corresponding to the CORESET is associated with the PCI.

In one embodiment, when a TCI state used for a PDCCH reception in a search space is indicated as being QCLed with a CSI-RS (Channel State Information-Reference Signal) resource and the CSI-RS resource is QCLed with an SSB identified by a PCI, the search space is associated with the PCI.

In one embodiment, when a TCI state used for a PDCCH reception in a CORESET is indicated as being QCLed with a CSI-RS resource and the CSI-RS resource is QCLed with an SSB identified by a PCI, a search space associated with the CORESET is associated with the PCI.

In one embodiment, Q2 is less than the Q, any of the Q2 time-domain resources is one of the Q time-domain resources.

In one subembodiment of the above embodiment, Q1 is less than the Q, any of the Q1 time-domain resources is one of the Q time-domain resources.

In one subembodiment of the above embodiment, the third signaling indicates that at least one search space switches from being associated with the first PCI to being associated with a second PCI, and the behavior of monitoring a downlink control signaling is executed in the at least one search space: the first PCI is different from the second PCI.

In one embodiment of the above subembodiment, a cell identified by the first PCI is a serving cell of the first node, and a cell identified by the second PCI is not configured with ServCellIndex.

The above method facilitates the first node to receive a downlink control signaling through a cell identified by a second PCI, while maintaining the serving cell unchanged, to achieve inter-cell mobility on a lower protocol layer.

In one embodiment, for any PDCCH monitoring occasion in the Q time-domain resources, if there is an overlapping with any symbol configured as uplink in the TDD-UL-DL-ConfigCommon IE, the any PDCCH monitoring occasion does not belong to the Q1 time-domain resources; a cell identified by the second PCI is a serving cell of the first node, the third signaling indicates that at least one search space is associated with the first PCI, and the behavior of monitoring a downlink control signaling is executed in the at least one search space.

In one embodiment of the above subembodiment, a cell identified by the first PCI is not configured ServCellIndex.

In one embodiment, whether the first time-domain resource pool is a first candidate pool or a second candidate pool is related to a first RNTI, and the downlink control signaling is identified by the first RNTI.

In one embodiment, the downlink control signaling is identified by the first RNTI comprises: the first RNTI is used to scramble a CRC of the downlink control signaling.

In one embodiment, the downlink control signaling is identified by the first RNTI comprises: the first RNTI is used to generate an RS sequence of a DMRS (Demodulation Reference Signal) of the downlink control signaling.

In one embodiment, the downlink control signaling being identified by the first RNTI comprises: the first RNTI is used to determine time-frequency resources occupied by the downlink control signaling.

Typically, when the first RNTI belongs to a first type RNTI, the first time-domain resource pool is the first candidate resource pool; when the first RNTI belongs to a second-type RNTI, the first time-domain resource pool is the second candidate resource pool.

Typically, when the first RNTI belongs to a first type RNTI, the first time-domain resource pool is the first candidate resource pool; when the first RNTI belongs to a second-type RNTI, the third signaling indicates whether the first time-domain resource pool is the first time-domain resource pool or the second candidate resource pool.

In one embodiment, the first-type RNTI comprises a P-RNTI.

In one subembodiment of the above embodiment, the second-type RNTI comprises a C-RNTI.

In one subembodiment of the above embodiment, the second-type RNTI comprises an RNTI configured through a UE dedicated signaling.

In one subembodiment of the above embodiment, the second-type RNTI comprises an RNTI other than a P-RNTI.

In one embodiment, the first-type RNTI comprises an SI-RNTI.

In one embodiment, the first-type RNTI comprises an RA-RNTI.

In one embodiment, the first-type RNTI comprises an MsgB-RNTI.

In one embodiment, the second-type RNTI comprises an MCS-RNTI.

In one embodiment, the second-type RNTI comprises a C-RNTI.

In one subembodiment of the above embodiment, the second-type RNTI comprises a C-RNTI (Cell Radio Network Temporary Identifier), an MCS-C-RNTI, an SP (Semi-Persistent)-CSI-RNTI, and a CS (Configured Scheduling)-RNTI.

In one embodiment, whether the first time-domain resource pool is a first candidate pool or a second candidate pool depends on a type of a search space occupied by accommodating the downlink control signaling.

Typically, when the type of the search space occupied by the downlink control signaling belongs to one search space type in the first search space type set, the first time-domain resource pool is the first candidate resource pool; when the type of the search space occupied by the downlink control signaling belongs to a search space type in the second search space type set, the first time-domain resource pool is the second candidate resource pool.

Typically, when the type of the search space occupied by the downlink control signaling belongs to one search space type in the first search space type set, the first time-domain resource pool is the first candidate resource pool; when the type of the search space occupied by the downlink control signaling belongs to a search space type in the second search space type set, the third signaling indicates whether the first time-domain resource pool is the first time-domain resource pool or the second candidate resource pool.

In one embodiment, the first search space type set comprises at least one search space type of USS (UE-specific search space) set.

In one embodiment, the first search space type set comprises at least one search space type of Type0-PDCCH CSS set.

In one embodiment, the first search space type set comprises at least two search space types of Type0-PDCCH CSS set and USS set.

In one embodiment, the second search space type set comprises at least one search space type of Type2-PDCCH CSS set.

In one embodiment, the second search space type set comprises at least two search space types of Type2-PDCCH CSS set and Type3-PDCCH CSS set.

In one embodiment, whether the first time-domain resource pool is a first candidate pool or a second candidate pool is related to a CORESET occupied by accommodating the downlink control signaling.

Typically, when the CORESET occupied by the downlink control signaling belongs to a CORESET in a first CORESET set, the first time-domain resource pool is the first candidate resource pool; when the CORESET occupied by the downlink control signaling belongs to a CORESET in a second CORESET set, the first time-domain resource pool is the second candidate resource pool.

Typically, when the CORESET occupied by the downlink control signaling belongs to a CORESET in a first CORESET set, the first time-domain resource pool is the first candidate resource pool; when the CORESET occupied by the downlink control signaling belongs to a CORESET in a second CORESET set, the third signaling indicates whether the first time-domain resource pool is the first time-domain resource pool or the second candidate resource pool.

In one embodiment, there does not exist a CORESET belonging to the first CORESET and the second CORESET set at the same time.

In one embodiment, any CORESET in the first CORESET set and the second CORESET set is configured to the first node U1.

In one embodiment, a coresetPoolIndex of all CORESETs in the first CORESET set is a first value, and a coresetPoolIndex of all CORESETs in the second CORESET set is a second value; the first value is different from the second value.

In one embodiment, the first value is 0, and the second value is 1.

In one embodiment, the first value and the second value are respectively non-negative integers not greater than 8.

In one embodiment, the first CORESET set comprises at least CORESET #0.

In one embodiment, the second CORESET set comprises all CORESETs configured for the first node U1, except for the first CORESET set.

In one embodiment, the first node U1 is a UE, and the second node U2 is a base station.

In one subembodiment of the above embodiment, a transmitter of the third signaling is a first cell, and a transmitter of the downlink control signaling is a second cell, and both the first cell and the second cell are maintained by the second node U2.

In one embodiment, a transmitter of the first signaling and the second signaling is the first cell.

In one embodiment, a transmitter of the first signaling and the second signaling is the second cell.

### Embodiment 6

Embodiment 6 illustrates a schematic diagram of a first node being in communications with a first cell and a second cell according to one embodiment of the present application, as shown in FIG. 6.

The first node U3 receives Q1 SSBs in step S300; optionally, the first node U3 receives Q3 SSBs in step S300; the first node U3 monitors a downlink control signaling in a first time-domain resource in step S301;
a first cell U4 transmits Q1 SSBs in step S400;
optionally, the second cell U5 transmits Q3 SSBs in step S500; a second cell U5 transmits a downlink control signaling in a first time-domain resource in step S501.

In Embodiment 6, the Q3 SSBs respectively correspond to Q3 SSB indexes.

In one embodiment, any SSB index in the Q3 SSB indexes is a non-negative integer not greater than 63.

In one embodiment, any SSB index in the Q3 SSB indexes is a positive integer not greater than 64.

In one embodiment, the second signaling indicates Q2 SSB indexes in Q SSB indexes, and a third signaling indicates one SSB index: if the SSB index is one of the Q1 SSB indexes, the first time-domain resource pool is a first candidate pool, and the first integer is the SSB index: if the SSB index is one of the Q3 SSB indexes, the first time-domain resource pool is a second candidate pool, and the SSB index is used to calculate the first integer, and the first integer is one of the Q2 SSB indexes.

In one embodiment, the SSB index being used to calculate the first integer comprises: the first integer is Mod (the SSB index, Q2).

In one embodiment, the SSB index being used to calculate the first integer comprises: the Q3 SSB indexes are sorted in order of size, and the first integer is Mod (a position of the SSB index in the sorted Q3 SSB indexes, Q2).

In one embodiment, at least the first node U3 assumes that SSBs corresponding to the Q2 SSB indexes are not transmitted by the first cell U4.

Typically, both the first cell U4 and the second cell U5 are maintained by a second node: the first signaling in the present application is SIB (System Information Block) 1; the second signaling in the present application is generated at the RRC layer: the third signaling referred to in the present application is either a MAC CE or a DCI.

In one embodiment, the first cell U4 is a serving cell of the first node U3, and the second cell U5 is not configured with ServCellIndex.

In one subembodiment of the above embodiment, Q1 is smaller than Q, and the Q2 is smaller than the Q in the present application, and the Q time-domain resources consist of the Q1 time-domain resources and the Q2 time-domain resources.

In one subembodiment of the above embodiment, Q1 is equal to the Q, and the Q1 time-domain resources are the Q time-domain resources; Q2 is less than the Q in the present application, and any of the Q2 time-domain resources is one of the Q time-domain resources.

In one embodiment, the second cell U5 is a serving cell of the first node U3, and the first cell U4 is not configured with ServCellIndex.

In one subembodiment of the above embodiment, at least one of the Q2 time-domain resources is a true subset of one of the Q time-domain resources.

In one embodiment, the Q1 SSBs and the Q3 SSBs are transmitted on a same BWP (Bandwidth Part).

In one embodiment, the Q1 SSBs and the Q3 SSBs are transmitted on a same carrier.

In one embodiment, a first PCI is used to generate the Q1 SSBs, and a second PCI is used to generate the Q3 SSBs.

In one embodiment, a second PCI is used to generate the Q1 SSBs, and a first PCI is used to generate the Q3 SSBs.

### Embodiment 7

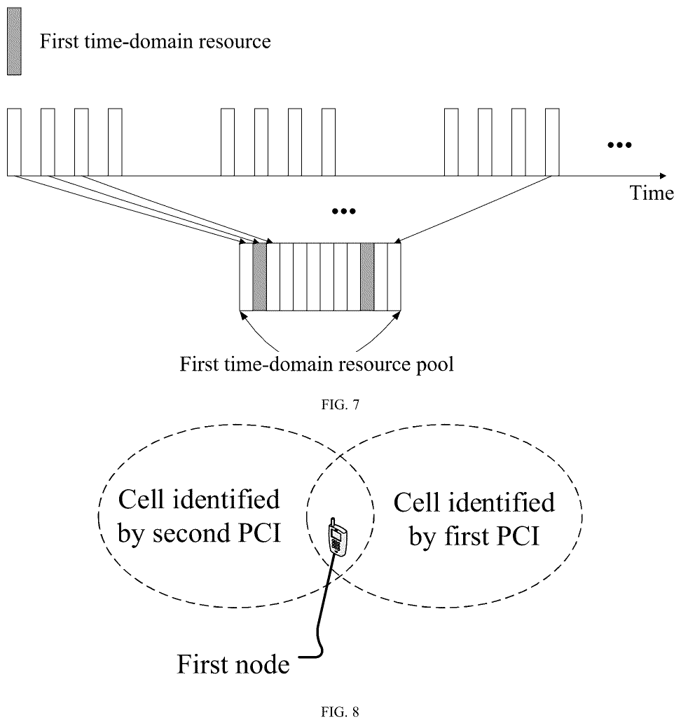

Embodiment 7 illustrates a schematic diagram of a first time-domain resource pool according to one embodiment of the present application, as shown in FIG. 7. In FIG. 7, a small grid represents a PDCCH monitoring occasion in a first time-domain resource pool, where the gray filled small grid belongs to a first time-domain resource.

In one embodiment, monitoring of a downlink control signaling by the first node is periodically executed, and the first time-domain resource pool consists of all PDCCH monitoring occasions that can be occupied by the downlink control signaling within one cycle.

In one embodiment, a PDCCH monitoring occasion belongs to a slot.

In one embodiment, a PDCCH monitoring occasion belongs to a span.

In one embodiment, a number of PDCCH monitoring occasion(s) belonging to the first time-domain resource pool spaced between any two adjacent PDCCH monitoring occasions in the first time-domain resource pool is the same.

In one embodiment, the period is a PO for a first cell, and the first cell is identified by a first PCI.

In one embodiment, the period is an SI-window for a first cell, and the first cell is identified by a first PCI.

In one embodiment, when the first time-domain resource pool is the first candidate pool, the all PDCCH monitoring occasions that can be occupied by the downlink control signaling do not comprise a PDCCH monitoring occasion with an overlapping with an PFDM symbol configured as uplink by tdd-UL-DL-ConfigurationCommon transmitted by a first cell, and the first cell is identified by a first PCI: tdd-UL-DL-ConfigurationCommon transmitted by a second cell is not used by a first node to determine the all PDCCH monitoring occasions that can be occupied by the downlink control signaling, and the second cell is identified by a second PCI.

In one embodiment, both the first cell and the second cell can transmit data to the first node.

In one embodiment, both the first cell and the second cell can receive data from the first node.

In one embodiment, a first RNTI is used to identify the downlink control signaling, and when the first node performs blind decoding on the first RNTI in a PDCCH monitoring occasion, the PDCCH monitoring occasion can be occupied by the downlink control signaling.

In one embodiment, a first RNTI is used to identify the downlink control signaling, and when the first node does not perform blind decoding on the first RNTI in a PDCCH monitoring occasion, the PDCCH monitoring occasion cannot be occupied by the downlink control signaling.

### Embodiment 8

Embodiment 8 illustrates a schematic diagram of a cell coverage status of the first node according to one embodiment of the present application, as shown in FIG. 8.

In one embodiment, an RRC layer of the first node terminates at the cell identified by the reference PCI.

In one embodiment, a PDCP (Packet Data Convergence Protocol) layer of the first node terminates at the cell identified by the reference PCI.

In one embodiment, the RLC (Radio Link Control) layer of the first node terminates at the cell identified by the reference PCI.

In one embodiment, a MAC sublayer of the first node terminates at the cell identified by the reference PCI.

In one embodiment, the cell identified by the reference PCI is a physical cell.

In one embodiment, the cell identified by the reference PCI is a serving cell of the first node.

In one embodiment, the cell identified by the target PCI is a physical cell.

In one embodiment, the cell identified by the target PCI is a serving cell of the first node.

In one embodiment, the cell identified by the target PCI is not a serving cell of the first node.

In one embodiment, the cell identified by the target PCI provides extra resources above the cell identified by the reference PCI.

In one embodiment, the cell identified by the target PCI is a candidate cell configured for L1/L2 mobility:

In one embodiment, the cell identified by the target PCI and the cell identified by the reference PCI are intra-frequency.

In one embodiment, the cell identified by the target PCI and the cell identified by the reference PCI are inter-frequency.

In one embodiment, the cell identified by the target PCI is a mobile management cell configured for the cell identified by the reference PCI.

In one embodiment, when the first node utilizes the cell identified by the target PCI to transmit data, a serving cell of the first node remains unchanged.

In one subembodiment of the above embodiment, the phrase of the phrase that a serving cell remains unchanged comprises: protocol stacks in at least one of RRC layer, PDCP layer, RLC layer, MAC sublayer, or PHY layer do not require relocation.

In one subembodiment of the above embodiment, the phrase of the phrase that a serving cell remains unchanged comprises: an RRC connection remains unchanged.

In one subembodiment of the above embodiment, the phrase of the phrase that a serving cell remains unchanged comprises: a serving cell identifier remains unchanged.

In one subembodiment of the above embodiment, the phrase of the phrase that a serving cell remains unchanged comprises: all or part of configuration in ServingCellConfigCommon and/or ServingCellConfigCommonSIB configuration remains unchanged.

In one embodiment, different RNTIs are used to determine a scrambling sequence of a physical-layer channel transmitted or received by the first node in the cell identified by the target PCI and a scrambling sequence of a physical-layer channel transmitted or received in the cell identified by the reference PCI.

In one subembodiment of the above embodiment, the physical-layer channel comprises one or more of a PDCCH, a PDSCH, a PUCCH (Physical Uplink Control Channel) or a PUSCH (Physical Uplink Shared Channel).

In one embodiment, a CRC of a PDCCH received by the first node in the cell identified by the target PCI and a CRC of a PDCCH received in the cell identified by the reference PCI are scrambled by different RNTIs.

In one embodiment, the first PCI in the present application is the reference PCI, and the second PCI in the present application is the target PCI.

In one embodiment, the second PCI in the present application is the reference PCI, and the first PCI in the present application is the target PCI.

### Embodiment 9

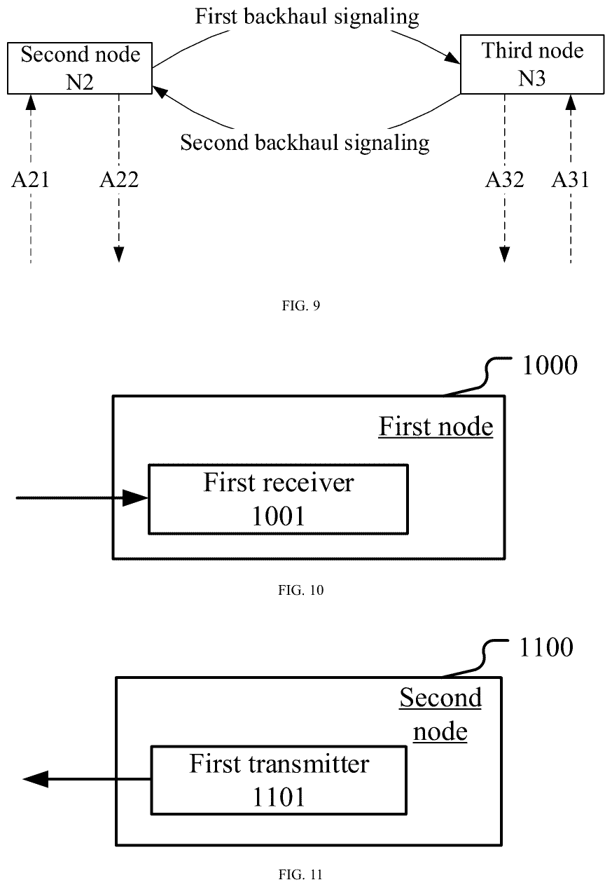

Embodiment 9 illustrates a schematic diagram of transferring a backhaul signaling between a first node and a second node according to one embodiment of the present application, as shown in FIG. 9. FIG. 9 describes a full duplex working mode, where a first backhaul signaling and a second backhaul signaling are both transmitted through an air interface.

Typically, the second node N2 and the third node N3 are each a base station.

In one embodiment, a transmission of the first backhaul signaling overlaps with an uplink reception of the second node N2 (as shown by arrow A21) in time, and a reception of the first backhaul signaling overlaps with an uplink reception of the third node N3 (as shown by arrow A31) in time: the second node N2 transmits the first backhaul signaling in a full duplex manner.

In one embodiment, a transmission of the first backhaul signaling overlaps in time with a downlink transmission of the second node N2 (as shown by arrow A22), and a reception of the first backhaul signaling overlaps in time with a downlink transmission of the third node N3 (as shown by arrow A32): the third node N3 transmits the first backhaul signaling in a full duplex manner.

In one embodiment, a reception of the second backhaul signaling overlaps with an uplink reception of the second node N2 (as shown by arrow A21) in time, and a transmission of the second backhaul signaling overlaps with an uplink reception of the third node N3 (as shown by arrow A31) in time: the third node N3 transmits the first backhaul signaling in a full duplex manner.

In one embodiment, a reception of the second backhaul signaling overlaps in time with a downlink transmission of the second node N2 (as shown by arrow A22), and a transmission of the second backhaul signaling overlaps in time with a downlink transmission of the third node N3 (as shown by arrow A32): the second node N2 transmits the first backhaul signaling in a full duplex manner.

In one embodiment, Q2 SSB indexes respectively correspond to Q2 SSBs, and radio resources reserved for the Q2 SSBs are allocated to the first backhaul signaling or the second backhaul signaling for inter-base station information exchange: the present application can avoid the first node from measuring Q2 SSBs; meanwhile, the embodiment allows the first node to receive a downlink control signaling on a PDCCH monitoring occasion associated with the Q2 SSBs, avoiding waste of time-frequency resources and improving transmission efficiency.

### Embodiment 10

Embodiment 10 illustrates a structure block diagram of a processor in a first node according to one embodiment of the present application, as shown in FIG. 10. In FIG. 10, a processor 1000 in a first node comprises a first receiver 1001.

In embodiment 10, the first receiver 1001 receives a first signaling and a second signaling, the first signaling indicates that Q SSBs are transmitted, and the Q SSBs respectively correspond to Q SSB indexes, the Q SSB indexes are respectively used to determine Q time-domain resources, Q being a positive integer greater than 1; determines a first time-domain resource based on at least a first integer, a candidate of the first time-domain resource constitutes a first time-domain resource pool; monitors a downlink control signaling in the first time-domain resource;

In embodiment 10, the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

In one embodiment, the first receiver 1001 receives a third signaling, the third signaling is used to determine whether the first time-domain resource pool is a first candidate pool or a second candidate pool.

In one embodiment, the second signaling indicates Q2 SSB indexes in the Q SSB indexes, and the Q2 SSB indexes are respectively used to determine the Q2 time-domain resources.

In one embodiment, at least for the first node, SSBs corresponding to the Q2 SSB indexes are considered not actually transmitted.

In one embodiment, for any of the Q2 time-domain resources, the Q time-domain resources comprise a corresponding time-domain resource; the second signaling is used to indicate the any time-domain resource from the corresponding time-domain resource.

In one embodiment, the Q time-domain resources each hold Q groups of CSS sets, and each of Q groups of CSS sets comprises at least one CSS set.

In one embodiment, whether the first time-domain resource pool is a first candidate pool or a second candidate pool is related to a first RNTI, and the downlink control signaling is identified by the first RNTI: or, whether the first time-domain resource pool is a first candidate pool or second candidate pool is related to a CORESET accommodating the downlink control signaling.

In one embodiment, the first node is a UE.

In one embodiment, the first node is a relay node.

In one embodiment, the first receiver 1001 comprises the antenna 452, the receiving processor 456, the multi-antenna receiving processor 458, and the controller/processor 459 in embodiment 4.

In one embodiment, the first receiver 1001 comprises at least one of the memory 460 or the data source 467 in embodiment 4.

### Embodiment 11

Embodiment 11 illustrates a structure block diagram of a processor in a second node according to one embodiment of the present application, as shown in FIG. 11. In FIG. 11, a processor 1100 in a second node comprises a first transmitter 1101.

In embodiment 11, the first transmitter 1101 transmits a first signaling and a second signaling, the first signaling indicates that Q SSBs are transmitted, and the Q SSBs respectively correspond to Q SSB indexes, and the Q SSB indexes are respectively used to determine Q time-domain resources, Q being a positive integer greater than 1;

In embodiment 11, at least a first integer is used to determine a first time-domain resource, and a candidate of the first time-domain resource constitutes a first time-domain resource pool; the first time-domain resource is reserved for a downlink control signaling; the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

In one embodiment, the first transmitter 1101 transmits a third signaling, the third signaling is used to determine whether the first time-domain resource pool is a first candidate pool or a second candidate pool.

In one embodiment, the second signaling indicates Q2 SSB indexes in the Q SSB indexes, and the Q2 SSB indexes are respectively used to determine the Q2 time-domain resources.

In one embodiment, at least for the first node, SSBs corresponding to the Q2 SSB indexes are considered not actually transmitted.

In one embodiment, for any of the Q2 time-domain resources, the Q time-domain resources comprise a corresponding time-domain resource; the second signaling is used to indicate the any time-domain resource from the corresponding time-domain resource.

In one embodiment, the Q time-domain resources each hold Q groups of CSS sets, and each of Q groups of CSS sets comprises at least one CSS set.

In one embodiment, whether the first time-domain resource pool is a first candidate pool or a second candidate pool is related to a first RNTI, and the downlink control signaling is identified by the first RNTI: or, whether the first time-domain resource pool is a first candidate pool or second candidate pool is related to a CORESET accommodating the downlink control signaling.

In one embodiment, the second node is a base station.

In one embodiment, the second node is a TRP.

In one embodiment, the second node is a relay node.

In one embodiment, the second node is a CU device.

In one embodiment, the second node is a DU device.

In one embodiment, the first transmitter 1101 comprises the antenna 420, the transmitter 418, the transmitting processor 416, and the multi-antenna transmitting processor 471 in embodiment 4.

In one embodiment, the first transmitter 1101 comprises at least one of the controller/processor 475 or the memory 476 in embodiment 4.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, vehicles, cars, RSUs, wireless sensors, network cards, Internet of Things (IoT) terminals, RFID terminals, NB-IoT terminals, Machine Type Communication (MTC) terminals, enhanced MTC (eMTC) terminals, data card, network cards, vehicle-mounted communication equipment, low-cost mobile phones, low-cost tablets and other wireless communication devices. The base station or system equipment in the present application includes but is not limited to macro-cellular base stations, micro-cellular base stations, Pico base stations, home base stations, relay base stations, eNB, gNB, Transmitter Receiver Points (TRPs), GNSS, relay satellites, satellite base stations, space base stations, RSUs, UAVs, test devices, such as a transceiver or a signaling tester that simulates some functions of a base station, and other wireless communication devices.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first signaling and a second signaling, the first signaling indicating that Q SSBs are transmitted, and the Q SSBs respectively corresponding to Q SSB indexes, the Q SSB indexes respectively being used to determine Q time-domain resources, Q being a positive integer greater than 1; determining a first time-domain resource based on at least a first integer, a candidate of the first time-domain resource constituting a first time-domain resource pool; monitoring a downlink control signaling in the first time-domain resource;
wherein the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

2. The first node according to claim 1, wherein the second signaling indicates Q2 SSB indexes in the Q SSB indexes, and the Q2 SSB indexes are respectively used to determine the Q2 time-domain resources.

3. The first node according to claim 2, wherein at least for the first node, SSBs corresponding to the Q2 SSB indexes are considered not actually transmitted.

4. The first node according to claim 1, wherein for any of the Q2 time-domain resources, the Q time-domain resources comprise a corresponding time-domain resource; the second signaling is used to indicate the any time-domain resource from the corresponding time-domain resource.

5. The first node according to claim 1, wherein the Q time-domain resources each hold Q groups of CSS (Common Search Space) sets, and each of Q groups of CSS sets comprises at least one CSS set.

6. The first node according to claim 1, comprising:
the first receiver, receiving a third signaling, the third signaling being used to determine whether the first time-domain resource pool is a first candidate pool or a second candidate pool.

7. The first node according to claim 1, wherein whether the first time-domain resource pool is a first candidate pool or a second candidate pool is related to a first RNTI, and the downlink control signaling is identified by the first RNTI; or, whether the first time-domain resource pool is a first candidate pool or second candidate pool is related to a CORESET accommodating the downlink control signaling.

8. A second node for wireless communications, comprising:
a first transmitter, transmitting a first signaling and a second signaling, the first signaling indicating that Q SSBs are transmitted, and the Q SSBs respectively corresponding to Q SSB indexes, the Q SSB indexes respectively being used to determine Q time-domain resources, Q being a positive integer greater than 1;
wherein at least a first integer is used to determine a first time-domain resource, and a candidate of the first time-domain resource constitutes a first time-domain resource pool; the first time-domain resource is reserved for a downlink control signaling; the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

9. The second node according to claim 8, wherein the first transmitter transmits a third signaling, the third signaling is used to determine whether the first time-domain resource pool is a first candidate pool or a second candidate pool.

10. The second node according to claim 8, wherein the second signaling indicates Q2 SSB indexes in the Q SSB indexes, and the Q2 SSB indexes are respectively used to determine the Q2 time-domain resources.

11. The second node according to claim 10, wherein SSBs corresponding to the Q2 SSB indexes are considered not actually transmitted by a receiver of the second signaling.

12. The second node according to claim 8, wherein for any of the Q2 time-domain resources, the Q time-domain resources comprise a corresponding time-domain resource; the second signaling is used to indicate the any time-domain resource from the corresponding time-domain resource.

13. The second node according to claim 8, wherein the Q time-domain resources each hold Q groups of CSS sets, and each of Q groups of CSS sets comprises at least one CSS set.

14. The second node according to claim 8, wherein whether the first time-domain resource pool is a first candidate pool or a second candidate pool is related to a first RNTI, and the downlink control signaling is identified by the first RNTI; or, whether the first time-domain resource pool is a first candidate pool or second candidate pool is related to a CORESET accommodating the downlink control signaling.

15. A method in a first node for wireless communications, comprising:
receiving a first signaling and a second signaling, the first signaling indicating that Q SSBs are transmitted, and the Q SSBs respectively corresponding to Q SSB indexes, the Q SSB indexes respectively being used to determine Q time-domain resources, Q being a positive integer greater than 1; determining a first time-domain resource based on at least a first integer, a candidate of the first time-domain resource constituting a first time-domain resource pool; monitoring a downlink control signaling in the first time-domain resource;
wherein the first integer is one of the Q SSB indexes, and the first time-domain resource belongs to a time-domain resource in the first time-domain resource pool, and the first time-domain resource pool is one of a first candidate pool and a second candidate pool; the first candidate pool comprises Q1 time-domain resources, and the second candidate pool comprises Q2 time-domain resources; any of the Q1 time-domain resources is one of the Q time-domain resources, and at least one of the Q1 time-domain resources does not belong to the Q2 time-domain resources; the Q2 time-domain resources are a true subset of the Q time-domain resources; the second signaling is used to determine the Q2 time-domain resources; the Q SSBs are associated with a first PCI.

16. The method in the first node according to claim 15, wherein the second signaling indicates Q2 SSB indexes in the Q SSB indexes, and the Q2 SSB indexes are respectively used to determine the Q2 time-domain resources.

17. The method in the first node according to claim 16, wherein at least for the first node, SSBs corresponding to the Q2 SSB indexes are considered not actually transmitted.

18. The method in the first node according to claim 15, wherein for any of the Q2 time-domain resources, the Q time-domain resources comprise a corresponding time-domain resource; the second signaling is used to indicate the any time-domain resource from the corresponding time-domain resource.

19. The method in the first node according to claim 15, wherein the Q time-domain resources each hold Q groups of CSS sets, and each of Q groups of CSS sets comprises at least one CSS set;
or,
whether the first time-domain resource pool is a first candidate pool or a second candidate pool is related to a first RNTI, and the downlink control signaling is identified by the first RNTI; or, whether the first time-domain resource pool is a first candidate pool or second candidate pool is related to a CORESET accommodating the downlink control signaling.

20. The method in the first node according to claim 15, comprising:
receiving a third signaling, the third signaling being used to determine whether the first time-domain resource pool is a first candidate pool or a second candidate pool.
